(19) United States
(12) Patent Application Publication
(10) Pub. No.: US 2020/0383025 A1
(43) Pub. Date: Dec. 3, 2020

(54) APPARATUS AND METHOD FOR SERVICE RECOVERY IN WIRELESS COMMUNICATION USING AUTO LEARNING

(71) Applicant: QUALCOMM Incorporated, San Diego, CA (US)

(72) Inventors: Srinivasarao PASUMARTHI, Hyderabad (IN); Sai Lokesh LADHAGIRI KRISHNAKUMAR, Hyderabad (IN); Sivakumar ANANDHANARAYANAN, Hyderabad (IN)

(21) Appl. No.: 16/874,207

(22) Filed: May 14, 2020

(30) Foreign Application Priority Data
May 31, 2019 (IN) 201941021734

(51) Int. Cl. H04W 36/24; H04W 36/14; H04W 36/30; H04W 76/19

(52) U.S. Cl. CPC H04W 36/245; H04W 76/19; H04W 36/305; H04W 36/14

(57) ABSTRACT

Aspects of the present disclosure provide an apparatus, system, and methods for a service recovery scan process in wireless communication using auto-learning mechanisms to record the location history of a user equipment (UE) during out-of-service (OOS) and service recovery. The UE determines that it lost service from a serving network. The UE determines its location where the UE lost the service. The UE determines a plurality of recovery networks corresponding to the serving network based on the location and a recovery history of the UE. The UE scans the plurality of recovery networks to recover service in an order based on respective weights of the plurality of recovery networks. The UE updates the weights based on the recovery history of the UE. Other aspects and features are also claimed and described.

### PRIORITY CLAIM

This application claims priority to and the benefit of Indian provisional patent application no. 201941021734 filed in the Indian Patent Office on May 31, 2019, the entire content of which is incorporated herein by reference as if fully set forth below in its entirety and for all applicable purposes.

### TECHNICAL FIELD

The technology discussed below relates generally to wireless communication systems, and more particularly, to apparatus, systems, and methods for wireless service recovery scanning Embodiments can provide and enable techniques for service recovery scanning using auto-learning (e.g., associating GPS and/or location data with out-of-network service reporting and/or recovery efforts).

### INTRODUCTION

Wireless communication technology has evolved from voice-only communications to also include the transmission of various data including voice and multimedia data in the third generation (3G), fourth generation (4G), and fifth generation (5G) networks. A wireless device uses a service acquisition algorithm to acquire service from a 3G, 4G, or 5G wireless network. With the increased number of supported radio access technologies, frequencies, and bandwidths supported by 5G networks, a UE may spend more time in service acquisition and recovery. This may lead to higher battery drain and other inefficient device operations and resource utilization.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

Aspects of the present disclosure provide an apparatus, system, and methods for a service recovery scan process in wireless communication using auto-learning processes to improve the scan process based on the geolocation history of a user equipment (UE) recorded during out-of-service (OOS) and service recovery.

One aspect of the present disclosure provides a method of wireless communication at a user equipment (UE). The UE determines a location of the UE where the UE lost communication service from a first network. The UE determines one or more second networks for recovering communication service based on the location and a service recovery history of the UE. The UE scans the one or more second networks to recover communication service in an order based on respective weights of the one or more second networks. Weights can indicate relative preference between networks (e.g., such as the one or more second networks).

Another aspect of the present disclosure provides an apparatus for wireless communication. The apparatus includes a transceiver configured for wireless communication, a memory, and a processor operatively coupled to the transceiver and the memory. The processor and the memory are configured to determine a location of the apparatus where the apparatus lost communication service from a first network. The processor and the memory are further configured to determine one or more second networks for recovering communication service based on the location and a service recovery history of the apparatus. The processor and the memory are further configured to scan the one or more second networks to recover communication service in an order based on respective weights of the one or more second networks. The weights indicate relative preference between the one or more second networks.

Another aspect of the present disclosure provides a user equipment (UE). The UE includes means for determining a location of the UE where the UE lost communication service from a first network. The UE further includes means for determining one or more second networks for recovering communication service based on the location and a service recovery history of the UE. The UE further includes means for scanning the one or more second networks to recover communication service in an order based on respective weights of the one or more second networks. The weights indicate relative preference between the one or more second networks.

Another aspect of the present disclosure provides a non-transitory computer-readable medium storing computer-executable code. The computer-executable code causes an apparatus to determine a location of the apparatus where the apparatus lost communication service from a first network. The computer-executable code further causes the apparatus to determine one or more second networks for recovering communication service based on the location and a service recovery history of the apparatus. The computer-executable code further causes the apparatus to scan the one or more second networks to recover communication service in an order based on respective weights of the one or more second networks. The weights indicate relative preference between the one or more second networks.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In a similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects of the disclosure.

FIG. 2 is a conceptual illustration of an example of a radio access network according to some aspects of the disclosure.

FIG. 3 is a diagram illustrating an example of user equipment movement in a radio access network according to some aspects of the disclosure.

FIG. 4 is a diagram illustrating a network scanning process according to some aspects of the disclosure.

FIGS. 5 and 6 are flow charts illustrating a service acquisition scan process using auto-learning principles according to some aspects of the disclosure

FIG. 7 is a diagram illustrating three exemplary entries of a recovery database for facilitating service recovery according to some aspects of the disclosure.

FIG. 8 is a flow chart illustrating a process for scanning recovery networks based on their relative weights according to some aspects of the disclosure.

FIG. 9 is a block diagram conceptually illustrating an example of a hardware implementation for a scheduled entity according to some aspects of the disclosure.

FIGS. 10 and 11 are flow charts illustrating an exemplary process for service recovery from an out-of-service condition according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

Aspects of the present disclosure provide an apparatus, system, and methods for recovering system access. Some deployments and implementations can include a fast or quick service recovery scan process in wireless communications. Aspects may also include using auto-learning processes. Auto-learning can leverage and improve scan processes based on location data (e.g., geolocation history of a user equipment (UE) recorded during out-of-service (OOS) and service recovery). In some scenarios, a UE can store historical geolocation information in one or more memories (e.g., databases when OOS and service recovery occur). Using geolocation information, a UE may relate an OOS network to a recovery network. Associations or relating networks may occur using auto-learning principles. In some deployments, auto-learning enables UEs to prioritize and/or scan frequency bands of recovery network(s) corresponding to the OOS network based on the UE's geolocation according to the databases.

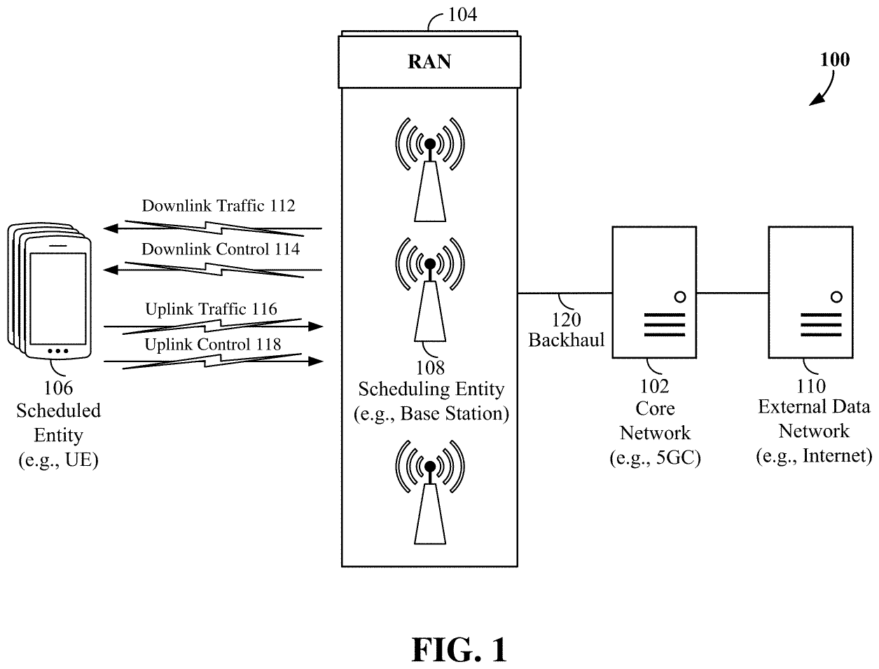

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

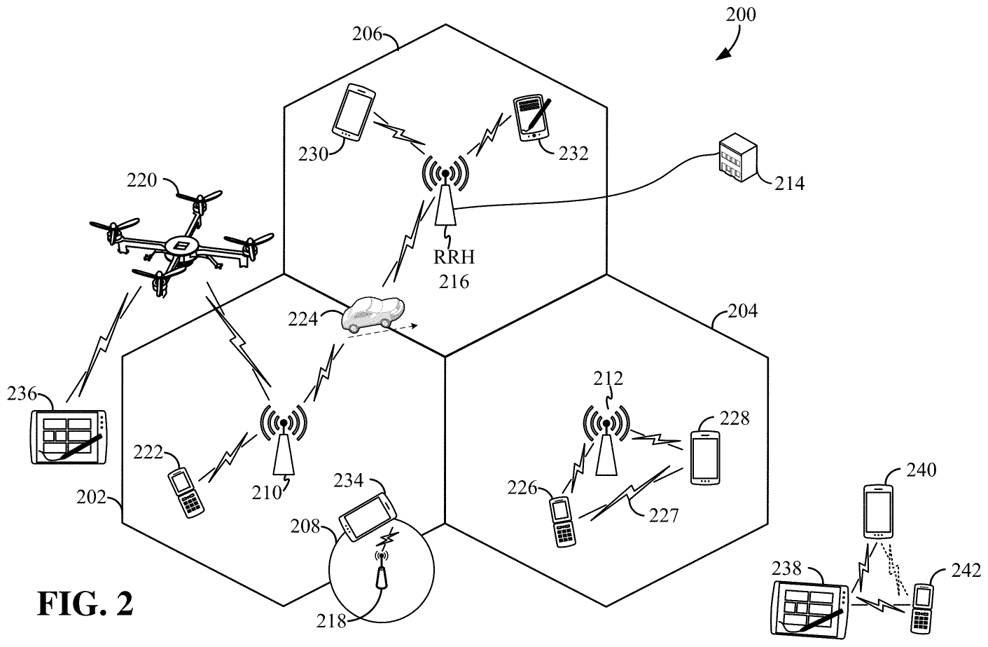

FIG. 2 is a conceptual illustration of an example of a radio access network (RAN) according to some aspects of the disclosure. In some examples, a RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 126 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1 and other scheduling entities described in this disclosure.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1. The UEs may communicate with the base stations using one or more radio access technology (RAT) and bands.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

In the radio access network 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1). The AMF may include a security context management function (SCMF) that manages the security context for both the control plane and the user plane functionality, and a security anchor function (SEAF) that performs authentication.

In various aspects of the disclosure, a radio access network 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the radio access network 200. Each of the cells may measure a strength of the pilot signal, and the radio access network (e.g., one or more of the base stations 210 and 214/216 and/or a central node within the core network) may determine a serving cell for the UE 224. As the UE 224 moves through the radio access network 200, the network may continue to monitor the uplink pilot signal transmitted by the UE 224. When the signal strength or quality of the pilot signal measured by a neighboring cell exceeds that of the signal strength or quality measured by the serving cell, the network 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell. Rather the synchronization signal may identify a zone of multiple cells operating on the same frequency and/or with the same timing. The use of zones in 5G networks or other next generation communication networks enables the uplink-based mobility framework and improves the efficiency of both the UE and the network. These benefits can be realized by a reduced number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The air interface in the radio access network 200 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

In order for transmissions over the radio access network 200 to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

In 5G New Radio (NR) specifications, user data may be coded in various manners. Some data can be coded using quasi-cyclic low-density parity check (LDPC) with two different base graphs: one base graph is used for large code blocks and/or high code rates, while the other base graph is used otherwise. Control information and the physical broadcast channel (PBCH) may be coded using Polar coding, based on nested sequences. For these channels, puncturing, shortening, and repetition are used for rate matching.

Aspects of the present disclosure may be implemented utilizing any suitable channel coding techniques. Various implementations of scheduling entities 108 and scheduled entities 106 may include suitable hardware and capabilities (e.g., an encoder, a decoder, and/or a CODEC) to utilize one or more of these channel codes for wireless communication.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

In order for a UE to gain initial access to a cell, the RAN may provide system information (SI) characterizing the cell. This system information may be provided utilizing minimum system information (MSI), and other system information (OSI). The MSI may be periodically broadcast over the cell to provide the most basic information required for initial cell access, and for acquiring any OSI that may be broadcast periodically or sent on-demand In some examples, the MSI may be provided over two different downlink channels. For example, the PBCH may carry a master information block (MIB), and a physical downlink shared channel (PDSCH) may carry a system information block type 1 (SIB1). In the art, SIB1 may be referred to as the remaining minimum system information (RMSI).

OSI may include any SI that is not broadcast in the MSI. In some examples, the PDSCH may carry a plurality of SIBs, not limited to SIB1, discussed above. Here, the OSI may be provided in these SIBs, e.g., SIB2 and above.

The channels or carriers described above and illustrated in FIGS. 1 and 2 are not necessarily all the channels or carriers that may be utilized between a scheduling entity 108 and scheduled entities 106, and those of ordinary skill in the art will recognize that other channels or carriers may be utilized in addition to those illustrated, such as other traffic, control, and feedback channels.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of resource blocks (RBs) in a given transmission.

### Service Acquisition Scan

Due to the mobile nature of a wireless device (e.g., UE), it can move from one place to another from time to time. Therefore, a UE may experience an out-of-service (OOS) scenario when the UE moves into an area with no wireless service or wireless services that are not supported by the UE. When the UE is OOS, it may perform a service acquisition scan or recovery scan to recover service from a network. In some aspects of the disclosure, the UE may maintain a database (e.g., an acquisition database), memory, or the like. These components can keep or store information on wireless systems or networks that have been acquired successfully during a prior service acquisition scan. For example, the database may have the public land and mobile network (PLMN) code, frequency band, and RAT of each network.

In some aspects of the disclosure, the UE may maintain a database or memory that provides information on a carrier preferred frequency list. In some aspects of the disclosure, the UE may maintain a database on frequency bands and RATs used in different countries or geographical regions. During a service acquisition or recovery scan, the UE scans the frequency bands and different RATs recorded in one or more databases to discover any available networks to acquire service. If the UE is moving frequently or continuously for an extended period of time beyond a coverage area of a network or cell, the UE may perform a lot of service acquisition scans that can drain the UE's battery quickly. When the UE supports multiple RATs (e.g., GSM, 3G, 4G, and 5G NR) and frequency bands, the UE may need to scan a large number of frequency bands and different RATs during the service acquisition scan. That can result in fast battery drain and inefficient scanning

### Exemplary Problematic Scenarios in Service Acquisition Scan

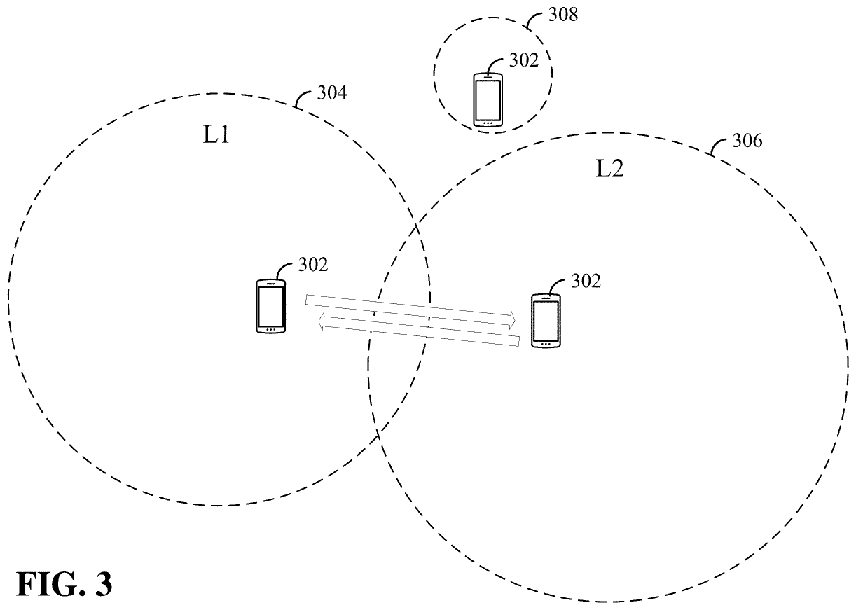

In one example, referring to FIG. 3, a UE 302 may move from a first location L1 to a second location L2 in a periodic manner For example, the UE may move between a first cell 304 and a second cell 306. The UE may lose a connection with a 5G NR network (OOS network) on a first channel F1 and recover a connection on a different RAT (e.g., GSM network) on a second channel G1 through the service acquisition scan. For example, the first cell 304 may be a cell of an NR network, and the second cell 306 may be a cell of a GSM network. In this case, the UE may need to scan a large number of channels or frequency bands during the service acquisition scan before the UE can find the second channel G1. In another example, the UE 302 may move to a location 308 (e.g., elevator or tunnel) where the UE cannot receive any usable signal from a network. In this scenario, it will be wasteful to perform the service acquisition scan where no service is available. In another example, the UE 302 may switch to a subscriber identity module (SIM) from a network operator different from the previous one. If the operators use different frequency bands, the UE may need to adjust the service acquisition scan to prioritize the new operator's frequency bands and/or de-prioritize the previous operator's frequency bands.

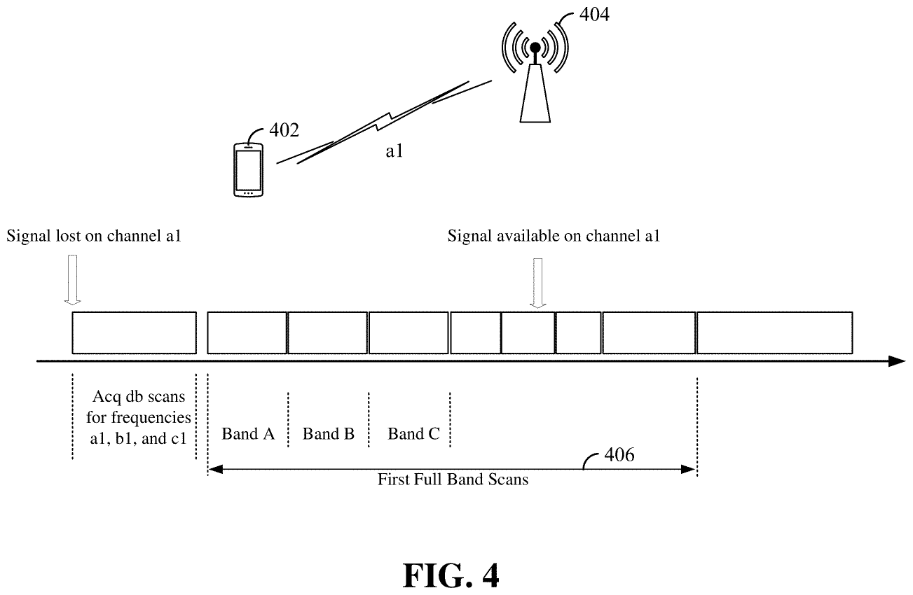

In yet another scenario, FIG. 4 is a drawing illustrating a UE 402 in wireless communication with a serving network 404. The UE 402 may communicate with the serving network 404 using a channel a1 that belongs to band A. When the UE loses the signal of the channel a1 from the serving network, the UE may start a service acquisition scan. During the service acquisition scan, the UE may first scan certain frequency bands recorded in an acquisition database. If the UE cannot find any service using the acquisition database, the UE may perform a full scan of all supported frequency bands and RATs. In some cases, the UE may not find the channel a1 during the acquisition database scan and the full scan. For example, in FIG. 4, the signal of the channel a1 in band A may become available in the middle of the first full scan 406 after scanning band A in the first full scan 406 and after an acquisition database scan. However, because the UE already scanned for channel a1 in band A earlier in the first full scan, the UE cannot detect the channel a1 until another cycle of acquisition scan or full scan after the first full scan.

Aspects of the present disclosure provide a service recovery scan method to facilitate service acquisition in a wireless network. Certain deployments and/or embodiments can use auto-learning principles. In this disclosure, auto-learning uses a process, procedure, or method that enables a device (e.g., UE) to learn and derive information in data collected from prior events (e.g., OOS, service recovery, and related location information) in order to continuously improve, update, or modify a process, e.g., a service recovery scan process. In one aspect of the disclosure, the UE stores historical geolocation information in one or more databases when OOS and service recovery occur. For example, when the UE acquires a new system (e.g., 5G NR, LTE, or 3G network), the UE may update a database to store the RAT and tracking area code (TAC) of the newly acquired system as well as the geolocation information of the UE. The TAC may be a unique code that is assigned to each tracking area (TA) of a wireless network. A TA may cover one or more cells or sectors. The UE may obtain the geolocation information (e.g., geocoordinates such as latitude and longitude) using a satellite-based positioning system. Exemplary satellite-based positioning systems include Global Positioning System (GPS), Global Navigation Satellite System (GLONASS), Galileo positioning system, etc. Using the geolocation information, the UE may relate the OOS network to the recovery network using auto-learning principles such that the UE scans only the frequency bands of recovery network(s) corresponding to the OOS network based on the UE's geolocation (location).

### Service Recovery Scan Process Using Auto-Learning

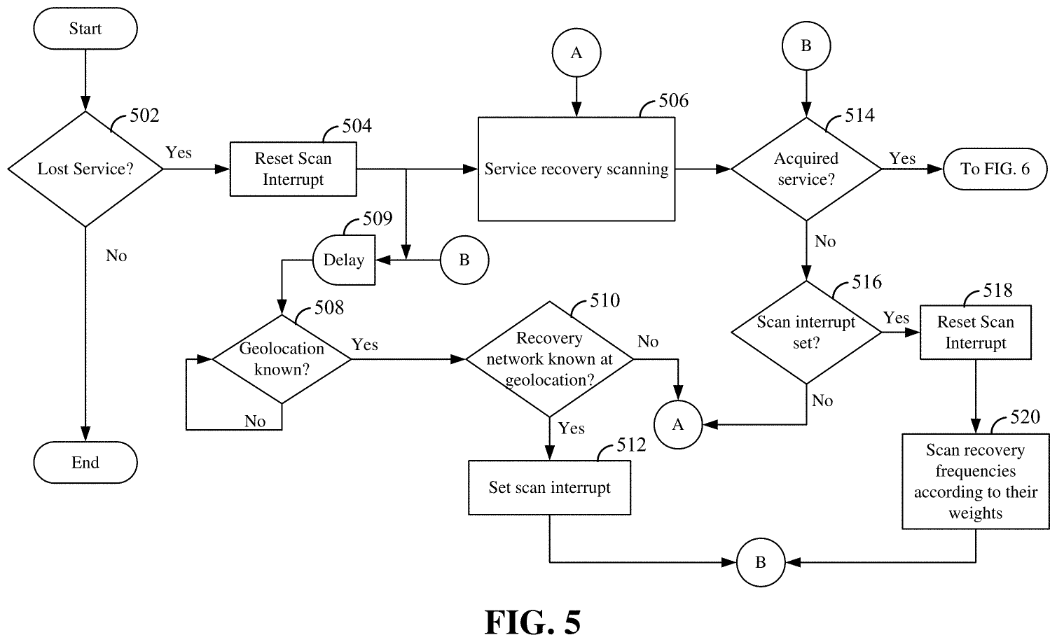

FIG. 5 is a flow chart illustrating a service recovery scan process using auto-learning principles according to some aspects of the disclosure. The recovery scan process may be used by any UEs or scheduled entities described in FIGS. 1-4 and 9. Referring to FIG. 5, at block 502, a UE determines that it has lost service from a network. For example, the UE loses service from a network when the UE cannot receive, detect, and/or decode a communication signal (e.g., a control channel and/or a data channel) from a serving network in a predetermined period of time. After the UE lost service from the network, at block 504, the UE resets a scan interrupt flag that is maintained by the UE. The scan interrupt flag may be set to a first value (e.g., 1) and reset to a second value (e.g., 0) that is different from the first value. The functions of the scan interrupt flag will be described in more detail below.

At block 506, after resetting the scan interrupt flag, the UE starts a service recovery scanning procedure. During the service recovery scanning procedure, the UE may scan through a number of supported frequency bands of one or more RATs until it can acquire or recover service from a network. The UE may select and scan the frequency bands in a predetermined order based on various criteria. For example, the UE may scan the known frequency bands available in the current geolocation (e.g., country), carrier preferred frequency bands, recently used frequency bands, etc. If the UE does not find any usable networks in the scan, the UE may restart or continue the scanning process at block 506 after a predetermined timeout period.

While the service recovery scanning procedure is ongoing (e.g., foreground task), at block 508, the UE may determine its current location or geolocation, for example, using satellite-based positioning. The UE may need a predetermined amount of time (represented as delay 509) to acquire and process the positioning signals from the satellites before the UE can determine its location. At decision block 508, the UE determines whether or not the current geolocation is known or determined. At decision block 510, if the UE has determined the current geolocation (e.g., latitude and longitude), the UE determines if a recovery network is known at or near the current geolocation. For example, the UE may check a recovery database that stores recovery network information identifying a plurality of recovery networks known for the current geolocation.

If a recovery system is not known at the current geolocation, the UE does not set a scan interrupt flag (i.e., not interrupting the ongoing service recovery scanning procedure). At block 512, if a recovery system is known at the current geolocation, the UE sets the scan interrupt flag. When the scan interrupt flag is set, the ongoing service recovery scanning procedure started at block 506 will be interrupted.

At decision block 514, the UE checks if the UE has acquired or recovered service during the service recovery scanning procedure. At decision block 516, if the UE has not acquired service yet, the UE checks the scan interrupt flag. If the scan interrupt flag is not set (i.e., no scanning interrupt), the UE does not interrupt the ongoing service recovery scanning procedure. At block 518, if the scan interrupt flag is set (i.e., interrupt scanning procedure), the UE resets the scan interrupt flag. Then, at block 520, the UE scans for the recovery networks recorded in a recovery database in an order according to the weights of the recovery networks recorded in the database. As discussed below, the weights or weight information can be pre-provisioned and/or generated during operation based on a variety of factors and stored in the recovery database or memory.

Associating use or weight information with networks enables efficient connectivity recovery according to aspects. For example, a scanning order of networks according to the recovery database is different from the scanning order used in the service recovery scanning procedure of block 506. Use of weights or indexes associated with a network can enable strategic and opportunistic scanning approaches. And these approaches can expedite scanning and selection of network for resuming connectivity and reconnection with a network. In some deployments, weights may indicate a relative priority or preference of the recovery networks when the UE scans the recovery networks. After scanning for the recovery networks using the recovery database, at block 514, the UE checks if it has acquired or recovered service, and the UE may contemporaneously determine its current location at block 508.

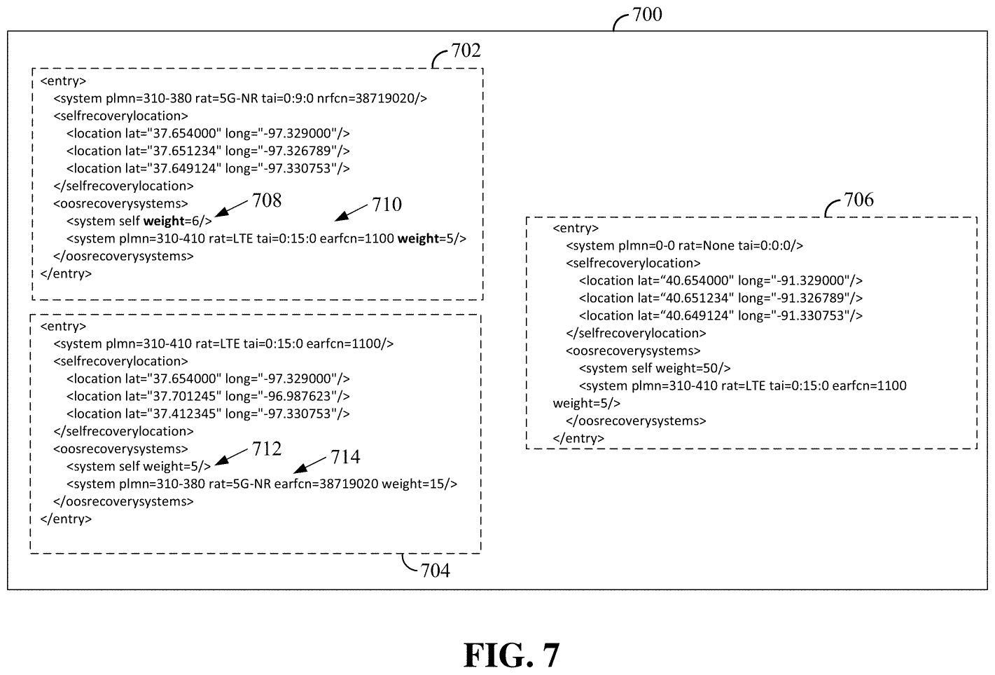

FIG. 7 illustrates three exemplary entries of a recovery database 700 for facilitating service recovery according to some aspects of the disclosure. The recovery database 700 may correspond to the recovery database described above in block 520 of FIG. 5. Whenever the UE acquires service from a wireless network, the UE creates an entry for the network in the database if an entry does not already exist for that network in the database. For example, the recovery database 700 has a first entry 702 that stores various information for a 5G NR network. The information may include the public land and mobile network (PLMN) code, RAT, TAC ID (TAI), and radio channel frequency of the network. In the first entry 702, the PLMN code is 310-380, the RAT is 5G NR, TAI is 0:9:0, and frequency (denoted as “nrfcn” in FIG. 7) is 38719020. The first entry 702 has a “selfrecoverylocation” field for recording the geolocation of the UE whenever the UE acquires service from this network. In this example, three sets of coordinates (e.g., latitude and longitude) are shown for the past three acquisitions. The recovery database may maintain any number of geolocations in the “selfrecoverylocation” field up to a predetermined maximum or limit. When the maximum or limit is reached, the UE may delete the oldest geolocation(s) in order to add a newer geolocation to the “selfrecoverylocation” field. In some examples, the UE may update the “selfrecoverylocation” field using suitable methods.

The first entry 702 also includes an “oosrecoverysystems” field for recording the historical information of recovery network(s) from which the UE recovered service after it had lost service from the previous network (i.e., OOS network). In this example, the “oosrecoverysystems” field shows that the UE recovered service from an LTE network (PLMN=310-410, RAT=LTE, TAI=0:15:0, frequency=1100, weight=5). The “oosrecoverysystems” field also includes a “system self weight” variable. The “weight” and “system self weight” variables are used for determining the scanning orders or network preferences when different recovery networks are available at the same geolocation (e.g., in accordance with block 520, shown in FIG. 5). The initial weight for a particular network may be predetermined (e.g., weight=1) when the entry is created in the database. Weight values can vary over time.

The database further includes a second entry 704 that stores similar types of information for the LTE network that is the recovery network stored in the first entry 702 described above Similarly, the 5G NR network of the first entry 702 is the recovery network for the LTE network of the second entry 704 when the UE goes OOS from the LTE network. In this case, the two database entries are interlinked because the serving network in one entry is the recovery network in the interlinked entry.

The recovery database may have a third entry 706 that is created when the UE cannot acquire any service at a certain location. In this case, the third entry 706 may be used for a NULL system or location. For example, the information of the NULL system may be denoted as PLMN=0-0, RAT=none, TAI=0:0:0. The “selfrecoverylocation” field records the geolocation(s) where the UE cannot acquire service. Three exemplary geolocations are shown in the third entries 706. The third entry 706 also has a “oosrecoverysystems” field where the UE can record the information of the recovery network(s). In this case, the LTE network (PLMN=310-410, RAT=LTE, TAI=0:15:0 EARFCN=1100) of the second entry 704 is the recovery network stored in the “oosrecoverysystems” field of the third entry 706.

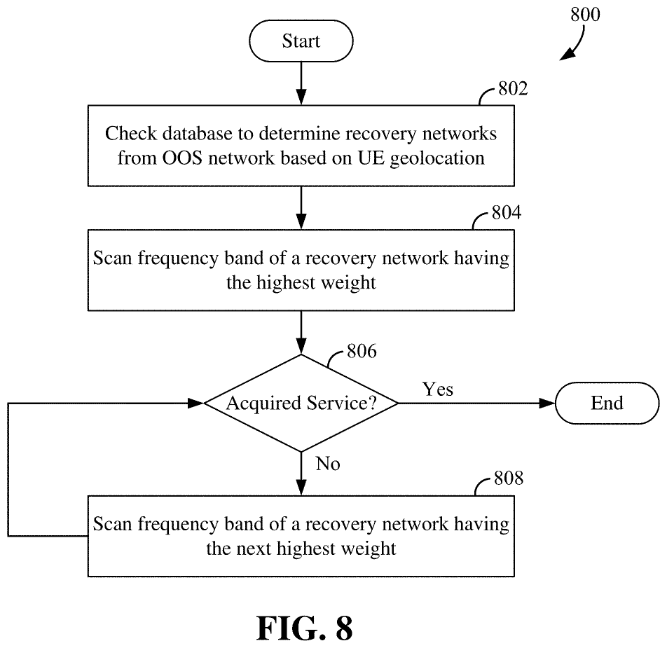

FIG. 8 is a flow chart illustrating a process 800 for scanning recovery networks based on their relative weights according to some aspects of the disclosure. The process 800 may be performed by any other UEs or scheduled entities described in relation to FIGS. 1-4. In one example, the UE may perform this process at block 520 of FIG. 5. At block 802, the UE checks or inquires the recovery database to determine the available recovery networks from the current OOS network based on the current geolocation of the UE. For example, each entry of the recovery database 700 corresponds to a network, and each entry has an “oosrecoverysystems” field that indicates the available recovery network(s) for that particular OOS network. At block 804, the UE scans the frequency band of a recovery network having the highest weight if there are more than one available recovery networks. At decision block 806, the UE determines if it has acquired or recovered service after scanning the frequency band of the recovery network. If the UE has not recovered service, at block 808, the UE scans the frequency band of another recovery network, if any available, with the next highest weight. This process continues until the UE acquires service or has scanned all available recovery networks according to the “oosrecoverysystems” field in a descending order of the weights of the recovery networks.

### Illustrative Examples

In the following two examples described with reference to FIG. 7, it is assumed that the UE's current geolocation is at latitude 37.654000 and longitude −97.329000. In a first example, if the OOS network is the 5G NR network corresponding to the first entry 702 in the database 700, the recovery networks at this geolocation (latitude 37.654000 and longitude −97.329000) are the same 5G NR network 708 and the LTE network 710 of the second entry 704 in the database. In the first entry 702, the 5G NR network 708 has a weight of 6, and the LTE network 710 has a weight of 5. Therefore, the UE scans the frequency band of the 5G NR network first then followed by scanning the frequency band of the LTE network.

In a second example, if the OOS network is the LTE network corresponding to the second entry 704 in the database, the recovery networks at this geolocation are the same LTE network 712 and the 5G NR network 714 corresponding to the first entry 702 in the database. In the second entry 704, the LTE network 712 has a weight of 5, and the 5G NR network 714 has a weight of 15. Therefore, the UE scans the frequency band of the 5G NR network first then followed by scanning the frequency band of the LTE network. Scanning the networks in an order (e.g., descending order from high to low weights) based on their weights may expedite the UE's service recovery time. In one approach, weights are set or updated using a learning algorithm of the UE's service recovery history that is kept in the database or memory. The learning algorithm will be described in more detail below. The above-described service recovery techniques may be applied to other examples to determine the scanning orders of the recovery networks based on the respective weights of the networks available at the current geolocation of the UE.

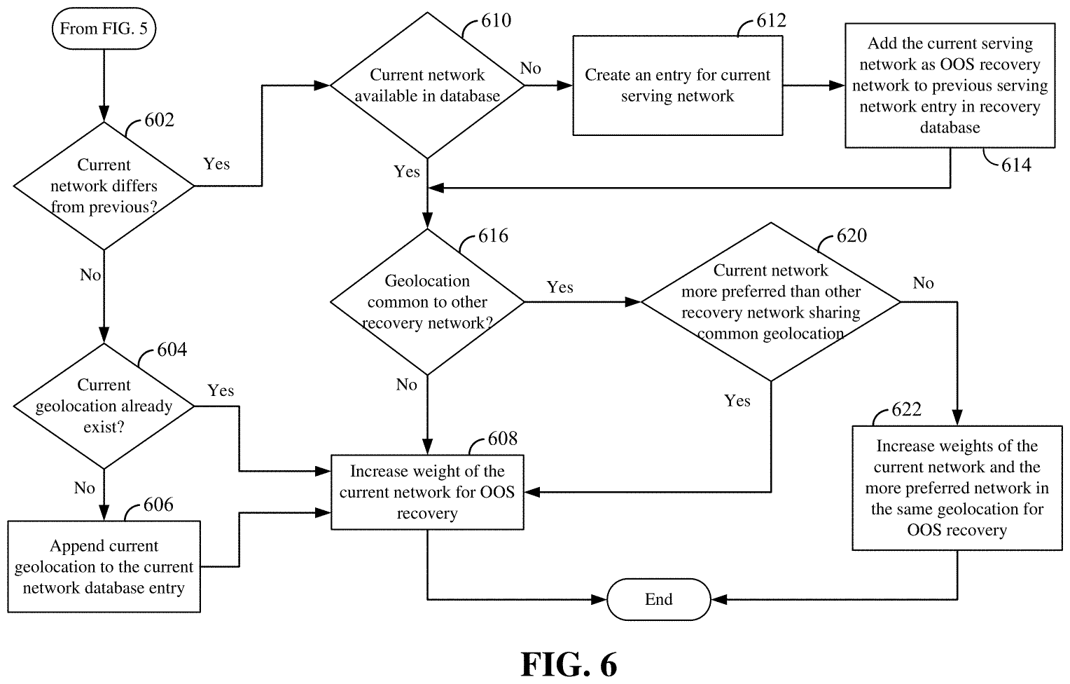

FIG. 6 is a flow chart illustrating a method of maintaining a recovery database used in a service recovery scan process using auto-learning principles according to some aspects of the disclosure. At decision block 602 (FIG. 6), after the UE has acquired service at block 514 of FIG. 5, the UE determines if the current serving network (recovery network) differs from the previous network (OOS network). If the UE has determined that the current network is the same (i.e., not different) as the previous network, at decision block 604, the UE further determines if the UE's current geolocation (e.g., latitude and longitude) already exists in the current serving network's entry in the database. If the UE has determined that the current network's database entry does not have the current geolocation, at block 606, the UE adds or appends the current geolocation to the database entry of the current network. Then, at block 608, the UE increases the weight of the current network in all corresponding entries of the database. In one example, the UE increases the weight of the current network by 1 or any predetermined value. For example, if the current network is the 5G NR network of the first entry 702 (see FIG. 7), the “system self weight” of the first entry 702 is increased by 1. In addition, the weight of the same 5G NR network in the interlinked second entry 704 is also increased by the same amount (e.g., 1).

If the UE has determined that the current network (recovery network) differs from the previous network (OOS network), at block 610, the UE determines if the current network is available in the recovery database. The current network is available in the database if the recovery database has an entry for the current network. If the UE has determined that the current network is not present in the recovery database, at block 612, the UE creates an entry for the current network in the recovery database. In some aspects of the disclosure, the UE may also add the frequency band and RAT information of the current network to a mobile control code (MCC) database that may be used to determine the frequency bands and RAT that are specific to the current MCC geography. At block 614, the UE adds the current serving network as the recovery network to the database entry of the previous serving network (OOS network). For example, the UE adds the current network to the “oosrecoverysystems” field of the database entry of the OOS network.

If the UE has determined that the current network is available in the recovery database, at block 616, the UE determines if the recovery geolocation of the current serving network is common to any other recovery networks in the recovery database. If the UE has determined that the current network (recovery network) does not have a common geolocation with other networks in the database, at block 608, the UE increases the weight of the current network for OOS recovery. For example, the UE may add 1 to the weight of the current network in the corresponding entries of the recovery database. If the UE has determined that the current network has a common geolocation with other network(s) in the database, at block 620, the UE determines if the current network is more preferred than the other recovery network(s) that share the same common geolocation. In one aspect, the UE may maintain a ranking order of the networks. A more preferred network ranks higher than a less preferred network according to the ranking order. The ranking order may be predetermined by the UE or a service carrier. If the determination is negative (no path), the UE proceeds to block 622; otherwise, if the determination is positive (yes path), the UE proceeds to block 608. At block 622, the UE increases the weights of both the current network and the more preferred network(s). For example, the UE may add a same value (e.g., 1) to each weight of the current network and the more preferred network in the corresponding entries of the recovery database such that the preference of the networks are preserved.

In the present disclosure, two geolocations may be considered the same or common if the difference between the geolocations is smaller than a predetermined distance. Therefore, two geolocations may have different latitudes and/or longitudes, but they may still be considered the same or common location in this disclosure when the two geolocations are sufficiently close to each other for practical applications of this disclosure.

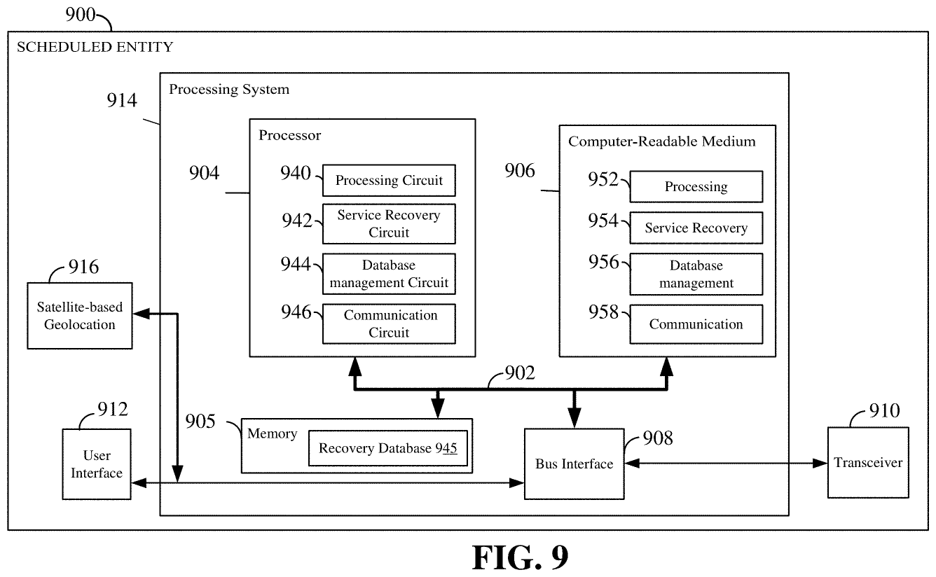

FIG. 9 is a block diagram illustrating an example of a hardware implementation for a scheduled entity 900 employing a processing system 914. For example, the scheduled entity 900 may be a user equipment (UE) as illustrated in any one or more of FIGS. 1, 2, 3, and/or 4.

The scheduled entity 900 may be implemented with a processing system 914 that includes one or more processors 904. Examples of processors 904 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduled entity 900 may be configured to perform any one or more of the functions described herein. That is, the processor 904, as utilized in a scheduled entity 900, may be used to implement any one or more of the processes and procedures described and illustrated in relation to FIGS. 5-8, 10, and 11.

In this example, the processing system 914 may be implemented with a bus architecture, represented generally by the bus 902. The bus 902 may include any number of interconnecting buses and bridges depending on the specific application of the processing system 914 and the overall design constraints. The bus 902 communicatively couples together various circuits including one or more processors (represented generally by the processor 904), a memory 905, and computer-readable media (represented generally by the computer-readable medium 906). The bus 902 may also link various other circuits such as timing sources, peripherals, voltage regulators, and power management circuits, which are well known in the art, and therefore, will not be described any further. A bus interface 908 provides an interface between the bus 902 and a transceiver 910. The transceiver 910 provides a communication interface or means for communicating with various other apparatus over a transmission medium. Depending upon the nature of the apparatus, a user interface 912 (e.g., keypad, display, speaker, microphone, joystick, touchscreen) may also be provided. Of course, such a user interface 912 is optional, and may be omitted in some examples, such as a base station. The scheduled entity 900 may include a satellite-based geolocation block 916 operatively coupled with the processing system 914. The satellite-based geolocation block 916 is configured to determine a current geolocation of the scheduled entity 900. For example, the satellite-based geolocation block 916 may use GPS, GLONASS, and/or Galileo positioning to determine the geolocation of the scheduled entity. In some examples, the scheduled entity 900 may use cellular-based and/or wireless network based triangulation techniques to determine its geolocation with or without using satellite-based positioning.

In some aspects of the disclosure, the processor 904 may include circuitry configured for various functions, including, for example, wireless service recovery. For example, the circuitry may be configured to implement one or more of the functions and processes described in relation to FIGS. 5-8, 10, and 11. In some aspects of the disclosure, the processor 904 may include a processing circuit 940, a service recovery circuit 942, a database management circuit 944, and a communication circuit 946. The processing circuit 940 may be configured to perform various data and signal processing and management functions of the scheduled entity, in cooperation with or without one or more other circuits of the scheduled entity. The service recovery circuit 942 may be configured to perform various functions to recover wireless communication service after the scheduled entity lost service from a serving wireless network. For example, the service recovery circuit 942 may perform various operations to scan the frequency bands and/or RATs of certain supported networks in order to recover service. The database management circuit 944 may be configured to maintain and query a recovery database 945 to facilitate the service recovery processes described in relation to FIGS. 5-8. In one example, the recovery database 945 may be similar to the recovery database 700 described above in relation to FIG. 7. The communication circuit 946 may be configured to perform various functions for wireless communication with one or more networks using various frequency bands and RATs via the transceiver 910.

The processor 904 is responsible for managing the bus 902 and general processing, including the execution of software stored on the computer-readable medium 906. The software, when executed by the processor 904, causes the processing system 914 to perform the various functions described in this disclosure for any particular apparatus. The computer-readable medium 906 and the memory 905 may also be used for storing data that is manipulated by the processor 904 when executing software.

One or more processors 904 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 906. The computer-readable medium 906 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer.

The computer-readable medium 906 may reside in the processing system 914, external to the processing system 914, or distributed across multiple entities including the processing system 914. The computer-readable medium 906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable medium 906 may include software configured for various functions, including, for example, service recovery and acquisition. For example, the software may be configured to implement one or more of the functions described in relation to FIGS. 5-8, 10, and 11. In some aspects of the disclosure, the software may include processing instructions 952, service recovery instructions 954, database management instructions 956, and communication instructions 958. The processor 904 may execute the processing instructions 952 to perform various data and signal processing, analyzing, manipulation, and management functions of the scheduled entity. The processor 904 may execute the service recovery instructions 954 to perform various functions to recover and acquire service after the scheduled entity lost service from a wireless network. The processor 904 may execute the database management instructions 956 to maintain, update, and query a recovery database to facilitate service recovery and acquisition. In one example, the database may be the recovery database 700 described above in relation to FIG. 7. The processor 904 may execute the communication instructions 958 to perform various functions for wireless communication with one or more networks or devices using various frequency bands and radio access technologies (RATs).

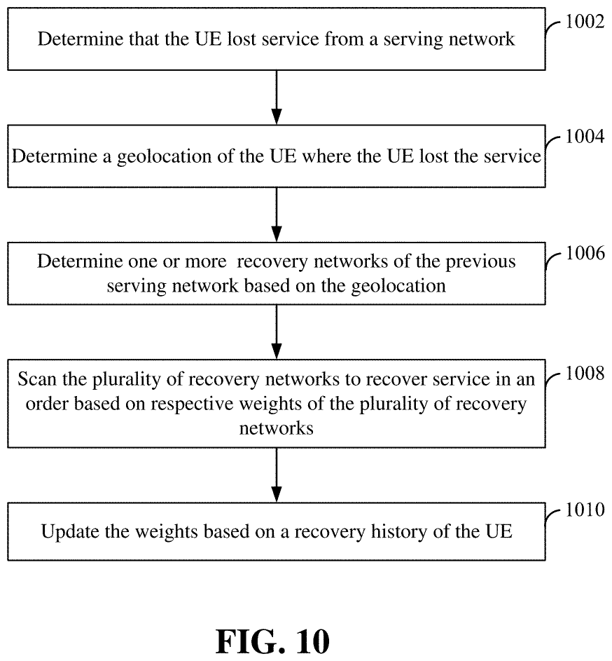

FIG. 10 is a flow chart illustrating an exemplary process 1000 for service recovery from an out-of-service condition in accordance with some aspects of the present disclosure. As described below, some or all illustrated features may be omitted in a particular implementation within the scope of the present disclosure, and some illustrated features may not be required for the implementation of all embodiments. In some examples, the process 1000 may be carried out by the scheduled entity 900 illustrated in FIG. 9. In some examples, the process 1000 may be carried out by any suitable apparatus (e.g., UE) or means for carrying out the functions or algorithm described below. In one aspect of the disclosure, the scheduled entity 900 may be one of the UEs or scheduled entities illustrated in FIGS. 1-4.

At block 1002, the UE determines that it has lost service from a current serving network (OOS network). For example, the UE may use the communication circuit 946 and the transceiver 910 to determine that it has lost service from the network when the UE cannot detect, decode, and/or receive the signal from the serving network. At block 1004, the UE determines a geolocation of the UE where the UE lost communication service from the OOS network (first network). In one example, the UE may use the satellite-based geolocation block 916 to determine the UE's geolocation (e.g., latitude and longitude) where the UE lost communication service. In another example, the UE may use cellular triangulation techniques to determine the UE's location.

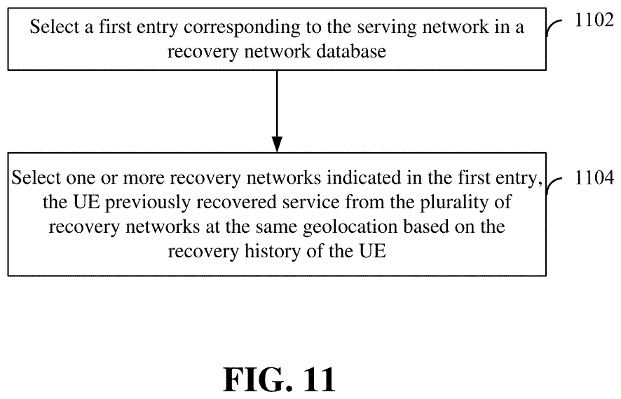

At block 1006, the UE determines one or more recovery networks (second networks) of the previous serving network based on the current geolocation. For example, the UE may use the service recovery circuit 942 to query the recovery database 945 to determine the potential recovery networks for recovery when the UE lost service from the previous serving network. For example, referring to FIG. 11, at block 1102, the UE may select a first entry (e.g., first entry 702 in database 700) corresponding to the previous serving network in a recovery database. Then, at block 1104, the UE selects one or more recovery networks indicated in the first entry. The UE previously recovered service from the one or more recovery networks at the same geolocation based on the recovery history of the UE. For example, the oosrecoverysystems field of the first entry indicates that the UE may recover service from the same serving network or an LTE network. Service recovery refers to the restoring or establishment of one or more control and/or data connections or channels with a serving network.

Referring back to FIG. 10, at block 1008, the UE scans the one or more recovery networks to recover communication service in an order based on respective weights of the one or more recovery networks. For example, the UE may use the communication circuit 946 and transceiver 910 to scan the frequency bands of the recovery networks. The weights indicate the relative preference between the one or more recovery networks. In one example, the UE may scan the recovery networks in an order starting with the highest weight and progressing to the next highest weight until all of the selected recovery networks are scanned. During the scanning, the UE may attempt to receive and decode timing and system information broadcasted from the recovery networks to acquire service. If UE can recover communication service from more than one of the recovery networks, the UE may select the preferred network, for example, 5G NR over LTE.

At block 1010, the UE may update the weights of the networks in the database based on a recovery history of the UE. For example, the UE may use the database management circuit 944 to update the weights of the recovery networks stored in the recovery database 945. The recovery history includes the UE's geolocations and recovery networks where the UE recovered from OOS. For example, the UE may use the process described above in relation to FIG. 6 to increase the weights of the recovery networks in the database according to the recovery history of the UE. When any of the weights of the recovery networks reaches a predetermined limit or maximum value, the UE may normalize the weights in the database. For example, the UE may divide the weights by a predetermined value.

The processes shown in FIGS. 10-11 may include additional aspects, such as any single aspect or any combination of aspects described below and/or in connection with one or more other processes described elsewhere herein.

In a first aspect, a UE may determine a location of the UE where the UE lost communication service from a first network. The UE may determine one or more second networks for recovering communication service based on the location and a service recovery history of the UE. The UE may scan the one or more second networks to recover communication service in an order based on respective weights of the one or more second networks. The weights may indicate relative preference between the one or more second networks.

In a second aspect, alone or in combination with the first aspect, the UE may compare the respective weights of the one or more second networks, and scan the one or more second networks in a descending order of the weights of the one or more second networks.

In a third aspect, alone or in combination with one or more of the first and second aspects, the UE may select, in a recovery network database, a first entry corresponding to the first network; and the UE may identify the one or more second networks included in the first entry. The UE previously recovered communication service from the identified one or more second networks at the same location based on the service recovery history of the UE.

In a fourth aspect, alone or in combination with one or more of the first through third aspects, the UE may recover communication service from a third network among the one or more second networks, and the third network corresponds to a second entry of the recovery network database. The UE may increase the weight of the third network included in one or more entries of the recovery network database.

In a fifth aspect, alone or in combination with one or more of the first through fourth aspects, if the third network ranks higher than a fourth network among the one or more second networks according to a ranking order of the networks, the UE may increase the weight of the third network without increasing the weight of the fourth network.

In a sixth aspect, alone or in combination with one or more of the first through fifth aspects, the UE may maintain the service recovery history in a recovery network database that includes a plurality of entries respectively corresponding to the first network and the one or more second networks. Each of the plurality of entries may include information on one or more locations where the UE previously acquired communication service.

In a seventh aspect, alone or in combination with one or more of the first through sixth aspects, the UE may record in each of the plurality of entries of the recovery network database, historical information of one or more networks from which the UE previously acquired service.

In one configuration, the apparatus 900 for wireless communication includes means for determining that the UE lost service from a serving network; means for determining a geolocation of the UE where the UE lost the service; means for determining one or more recovery networks of the serving network based on the geolocation of the UE; means for scanning the one or more recovery networks to recover service in an order based on respective weights of the one or more recovery networks; and means for updating the weights based on a recovery history of the UE. In one aspect, the aforementioned means may be the processor(s) 904 and various components shown in FIG. 9 configured to perform the functions recited by the aforementioned means. In another aspect, the aforementioned means may be a circuit or any apparatus configured to perform the functions recited by the aforementioned means.

In another configuration, aspects of the disclosure may include a method of wireless communication at a UE. The method can include determining one or more networks for recovering connectivity or communication service. Determination may be based on a location and a service recovery history of the UE. The method may include scanning one or more networks to recover communication service. Scanning can occur in an order based on respective weights associated with one or more of the networks. In certain deployments, weights can indicate relative preference among available networks. The method may optionally include determining a location of the UE where the UE lost communication service from an initial network.

In yet another deployment option, a wireless communication method is provided. Such a method may generally comprise determining that at least one network is configured for recovering communication service based on a UE's location and recovery history. A method may also include selecting the at least one network for communication. Network selection can be based on a respective weight associated with the at least one network. The weight may be an index value that indicates relative preference of the at least one network from one or more other networks. The respective weight of the at least one network may be updated based on the UE's recovery history using auto-learning.

Of course, in the above examples, the circuitry included in the processor 904 is merely provided as an example, and other means for carrying out the described functions may be included within various aspects of the present disclosure, including but not limited to the instructions stored in the computer-readable medium 906, or any other suitable apparatus or means described in any one of the FIGS. 1, 2, 3, and/or 4, and utilizing, for example, the processes and/or algorithms described herein in relation to FIGS. 5-8, 10, and/or 11.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as 5G NR, Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-11 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-11 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

What is claimed is:

1. A method of wireless communication at a user equipment (UE), comprising:
determining a location of the UE where the UE lost communication service from a first network;
determining one or more second networks for recovering communication service based on the location and a service recovery history of the UE; and
scanning the one or more second networks to recover communication service in an order based on respective weights of the one or more second networks, the weights indicating relative preference between the one or more second networks.

2. The method of claim 1, wherein the scanning the one or more second networks comprises:
comparing the respective weights of the one or more second networks; and
scanning the one or more second networks in a descending order of the weights of the one or more second networks.

3. The method of claim 1, wherein the determining the one or more second networks comprises:
selecting, in a recovery network database, a first entry corresponding to the first network; and
identifying the one or more second networks included in the first entry, wherein the UE previously recovered communication service from the identified one or more second networks at the same location based on the service recovery history of the UE.

4. The method of claim 3, further comprising:
recovering communication service from a third network among the one or more second networks, the third network corresponding to a second entry of the recovery network database; and
increasing the weight of the third network included in one or more entries of the recovery network database.

5. The method of claim 4, further comprising:
if the third network ranks higher than a fourth network among the one or more second networks according to a ranking order of the one or more second networks, increasing the weight of the third network without increasing the weight of the fourth network.

6. The method of claim 1, further comprising:
maintaining the service recovery history in a recovery network database comprising a plurality of entries respectively corresponding to the first network and the one or more second networks, each of the plurality of entries comprising information on one or more locations where the UE previously acquired communication service.

7. The method of claim 6, wherein the maintaining the service recovery history comprises:
recording in each of the plurality of entries of the recovery network database, historical information of one or more networks from which the UE previously acquired service.

8. An apparatus for wireless communication, comprising:
a transceiver configured for wireless communication;
a memory; and
a processor operatively coupled to the transceiver and the memory;
wherein the processor and the memory are configured to:
determine a location of the apparatus where the apparatus lost communication service from a first network;
determine one or more second networks for recovering communication service based on the location and a service recovery history of the apparatus;
scan the one or more second networks to recover communication service in an order based on respective weights of the one or more second networks, the weights indicating relative preference between the one or more second networks.

9. The apparatus of claim 8, wherein the processor and the memory are further configured to:
compare the respective weights of the one or more second networks; and
scan the one or more second networks in a descending order of the weights of the one or more second networks.

10. The apparatus of claim 8, wherein, for determining the one or more second networks, the processor and the memory are further configured to:
select, in a recovery network database, a first entry corresponding to the first network; and
identify the one or more second networks included in the first entry, wherein the apparatus previously recovered communication service from the identified one or more second networks at the same location based on the service recovery history of the apparatus.

11. The apparatus of claim 10, wherein the processor and the memory are further configured to:
recover communication service from a third network among the one or more second networks, the third network corresponding to a second entry of the recovery network database; and
increase the weight of the third network included in one or more entries of the recovery network database.

12. The apparatus of claim 11, wherein the processor and the memory are further configured to:
if the third network ranks higher than a fourth network among the one or more second networks according to a ranking order of the one or more second networks, increase the weight of the third network without increasing the weight of the fourth network.

13. The apparatus of claim 8, wherein the processor and the memory are further configured to:
maintain the service recovery history in a recovery network database comprising a plurality of entries respectively corresponding to the first network and the one or more second networks, each of the plurality of entries comprising information on one or more locations where the apparatus previously acquired communication service.

14. The apparatus of claim 13, wherein the processor and the memory are further configured to:
record in each of the plurality of entries of the recovery network database, historical information of one or more networks from which the apparatus previously acquired communication service.

15. A user equipment (UE), comprising:
means for determining a location of the UE where the UE lost communication service from a first network;
means for determining one or more second networks for recovering communication service based on the location and a service recovery history of the UE; and
means for scanning the one or more second networks to recover communication service in an order based on respective weights of the one or more second networks, the weights indicating relative preference between the one or more second networks.

16. The UE of claim 15, wherein the means for scanning the one or more second networks is configured to:
compare the respective weights of the one or more second networks; and
scan the one or more second networks in a descending order of the weights of the one or more second networks.

17. The UE of claim 15, wherein the means for determining the one or more second networks is configured to:
select, in a recovery network database, a first entry corresponding to the first network; and
identify the one or more second networks included in the first entry, wherein the UE previously recovered communication service from the identified one or more second networks at the same location based on the service recovery history of the UE.

18. The UE of claim 17, further comprising:
means for recovering communication service from a third network among the one or more second networks, the third network corresponding to a second entry of the recovery network database; and
means for increasing the weight of the third network included in one or more entries of the recovery network database.

19. The UE of claim 18, further comprising:
means for, if the third network ranks higher than a fourth network among the one or more second networks according to a ranking order of the one or more second networks, increasing the weight of the third network without increase the weight of the fourth network.

20. The UE of claim 15, further comprising:
means for maintaining the service recovery history in a recovery network database comprising a plurality of entries respectively corresponding to the first network and the one or more second networks, each of the plurality of entries comprising information on one or more locations where the UE previously acquired communication service.

21. The UE of claim 20, wherein the means for maintaining the service recovery history is configured to:
record in each of the plurality of entries of the recovery network database, historical information of one or more networks from which the UE previously acquired service.

22. A non-transitory computer-readable medium storing computer-executable code, comprising code for causing an apparatus to:
determine a location of the apparatus where the apparatus lost communication service from a first network;
determine one or more second networks for recovering communication service based on the location and a service recovery history of the apparatus; and
scan the one or more second networks to recover communication service in an order based on respective weights of the one or more second networks, the weights indicating relative preference between the one or more second networks.

23. The non-transitory computer-readable medium of claim 22, further comprising code for causing the apparatus to:
comparing the respective weights of the one or more second networks; and
scan the one or more second networks in a descending order of the weights of the one or more second networks.

24. The non-transitory computer-readable medium of claim 22, for determining the one or more second networks, further comprising code for causing the apparatus to:
select, in a recovery network database, a first entry corresponding to the first network; and
identify the one or more second networks included in the first entry, wherein the apparatus previously recovered communication service from the identified one or more second networks at the same location based on the service recovery history of the apparatus.

25. The non-transitory computer-readable medium of claim 24, further comprising code for causing the apparatus to:
recover communication service from a third network among the one or more second networks, the third network corresponding to a second entry of the recovery network database; and
increase the weight of the third network included in one or more entries of the recovery network database.

26. The non-transitory computer-readable medium of claim 25, further comprising code for causing the apparatus to:
if the third network ranks higher than a fourth network among the one or more second networks according to a ranking order of the one or more second networks, increase the weight of the third network without increase the weight of the fourth network.

27. The non-transitory computer-readable medium of claim 22, further comprising code for causing the apparatus to:
maintain the service recovery history in a recovery network database comprising a plurality of entries respectively corresponding to the first network and the one or more second networks, each of the plurality of entries comprising information on one or more locations where the apparatus previously acquired communication service.

28. The non-transitory computer-readable medium of claim 27, further comprising code for causing the apparatus to:
record in each of the plurality of entries of the recovery network database, historical information of one or more networks from which the apparatus previously acquired communication service.
